(19) United States
(12) Patent Application Publication
(10) Pub. No.: US 2013/0315665 A1
(43) Pub. Date: Nov. 28, 2013

(54) MOUNTING DEVICE

(71) Applicants: Stephen F. Heston, East Petersburg, PA (US); Francis B. Fatato, Exton, PA (US); Eric S. Mosser, Palmyra, PA (US)

(72) Inventors: Stephen F. Heston, East Petersburg, PA (US); Francis B. Fatato, Exton, PA (US); Eric S. Mosser, Palmyra, PA (US)

(73) Assignee: Fenner U.S., Inc., Manheim, PA (US)

(21) Appl. No.: 13/479,876

(22) Filed: May 24, 2012

(51) Int. Cl. F16D 1/05

(52) U.S. Cl. 403/374.4

(57) ABSTRACT

A mounting device for coaxially anchoring a machine element upon a rotary shaft. The device fits between the interior bore of the machine element and the surface of the shaft and is effective to position the element at any desired position longitudinally of the shaft and at any angular position circumferentially of the shaft. The device has inner and outer sleeves, the mating surfaces of which comprise tapered surfaces so that relative axial displacement of the sleeves effects expansion and contraction of the interior bore and external surface of the combined elements. Rotation of a threaded nut at one end of the device effects the relative axial displacement of the inner and outer sleeves to afford expansion and contraction of the sleeves.

### FIELD OF THE INVENTION

The present invention relates to a mounting device for mounting a machine element upon a shaft in such a manner that the rotation of the shaft transmits torque to the machine element without slippage due to the mounting. In particular, the device of the present invention provides an improved mounting device for mounting machine elements permitting infinitely-variable adjustment of the machine element on the shaft, both axially of the shaft and circumferentially thereof, and maintaining the machine element at a fixed, axial position after mounting on the shaft.

### BACKGROUND OF THE INVENTION

The use of devices for mounting machine elements, such as pulleys and gears, upon a shaft is well-known. One such device is disclosed in U.S. Pat. No. 5,695,297. Although such devices have been successful, the configuration of the devices have limitations in certain applications. For instance, when mounting an element on a smaller shaft, the ratio of the inner diameter to the outer diameter for the device increases, creating a relatively large overall package size for the device. Accordingly, there continues to be a need for an improved mounting device.

### SUMMARY OF THE INVENTION

In accordance with the present invention, a mounting device is provided that is easy to use. The device enables the mounting of a machine element by simply tightening a single nut to effect frictional engagement and also to ensure disengagement by loosening the same nut. The nut operates to positively release the frictional engagement produced by tightening the nut. Furthermore, the design of the present unit is of simple construction and is relatively inexpensive to manufacture.

A device for coaxially mounting a machine element having a bore upon a shaft includes an outer sleeve for engaging the machine element. The outer sleeve cooperates with a hollow inner sleeve. The inner sleeve has an internal diameter similar to a diameter of the shaft, and the inner sleeve comprises a first threaded portion cooperable with internal threads of the outer sleeve and a second threaded portion that cooperates with a locking nut. The device is tightened by rotating the locking nut in a first direction to drive the inner sleeve axially relative to the outer sleeve without substantially driving the inner sleeve angularly relative to the outer sleeve. Driving the inner sleeve axially relative to the outer sleeve drives the internal threads of the outer sleeve up the first threaded portion of the inner sleeve thereby expanding the outer sleeve into locking engagement with the machine element and contracting the inner sleeve inwardly into locking engagement with the shaft.

The present invention also provides another mounting device for mounting a machine element onto a shaft, comprising a hollow outer sleeve, a hollow inner sleeve and a locking nut. The outer sleeve is configured to mate with the machine element and the inner sleeve is configured to mate with the shaft. The inner sleeve comprises a first threaded portion threadedly engaging the internal threads of the outer sleeve and a second threaded portion threadedly engaging the locking nut. The device is tightened by rotating the locking nut in a first direction to drive the inner sleeve relative to the outer sleeve.

The present invention further provides a mounting device for mounting a machine element onto a shaft, wherein the machine element comprises an internally threaded portion. The device includes a hollow sleeve cooperable with the shaft and external threads cooperable with the internal threads of the machine element. The sleeve also includes a threaded portion cooperable with internal threads of a locking nut. The device is tightened by rotating the locking nut in a first direction to drive the sleeve axially relative to the machine element without substantially driving the sleeve angularly relative to the machine element.

The present invention also provides a method for mounting a machine element onto a shaft. According to the method, a first sleeve is inserted into the bore of a machine element. The first sleeve comprises a first externally threaded portion that cooperates with an internally threaded portion in the machine element or in a second sleeve. The first threaded portion of the first sleeve is threaded into the internally threaded portion and the inner sleeve is positioned on a shaft. A locking nut is threadedly engaged with the inner sleeve, and the method includes the step of rotating the locking nut relative to the inner sleeve to drive the inner sleeve axially relative to the internally threaded portion without substantially driving the inner sleeve angularly relative to the internally threaded portion, thereby tightening the inner sleeve to lock the inner sleeve on the shaft and to lock the inner sleeve relative to the machine element.

### BRIEF DESCRIPTION OF THE DRAWINGS

The foregoing summary, as well as the following detailed description of the preferred embodiments of the present invention, will be better understood when read in conjunction with the appended drawings, in which:

FIG. 1 is an exploded perspective view of a mounting device;

FIG. 2 is an end view of the assembled mounting device as seen from the left end of FIG. 1;

FIG. 3 is a transverse sectional view of the assembled mounting device shown in FIG. 2, taken on the section line 3-3 of FIG. 2;

FIG. 4 is an enlarged fragmentary section view of the mounting device shown in FIG. 1;

FIG. 5 is the transverse view of FIG. 3 shown in combination with a machine element and a shaft;

FIG. 6 is an exploded perspective view of a mounting device;

FIG. 7 is an end view of the mounting device illustrated in FIG. 6;

FIG. 8 is a transverse sectional view taken along the line 8-8 of FIG. 7;

FIG. 9 is an exploded perspective view of a mounting device;

FIG. 10 is an end view of the mounting device illustrated in FIG. 9;

FIG. 11 is a transverse sectional view taken along the line 11-11 of FIG. 10;

FIG. 12 is a transverse sectional view of a mounting device;

FIG. 13 is a perspective view of a sleeve of the mounting device illustrated in FIG. 12;

FIG. 14 is an exploded perspective view of a mounting device;

FIG. 15 is an end view of the mounting device illustrated in FIG. 14;

FIG. 16 is a transverse sectional view taken along the line 16-16 of FIG. 15;

FIG. 17 is an exploded perspective view of a mounting device;

FIG. 18 is an end view of the mounting device illustrated in FIG. 17;

FIG. 19 is a transverse sectional view taken along the line 19-19 of FIG. 18; and

FIG. 20 is a sectional view of a mounting device.

### DETAILED DESCRIPTION

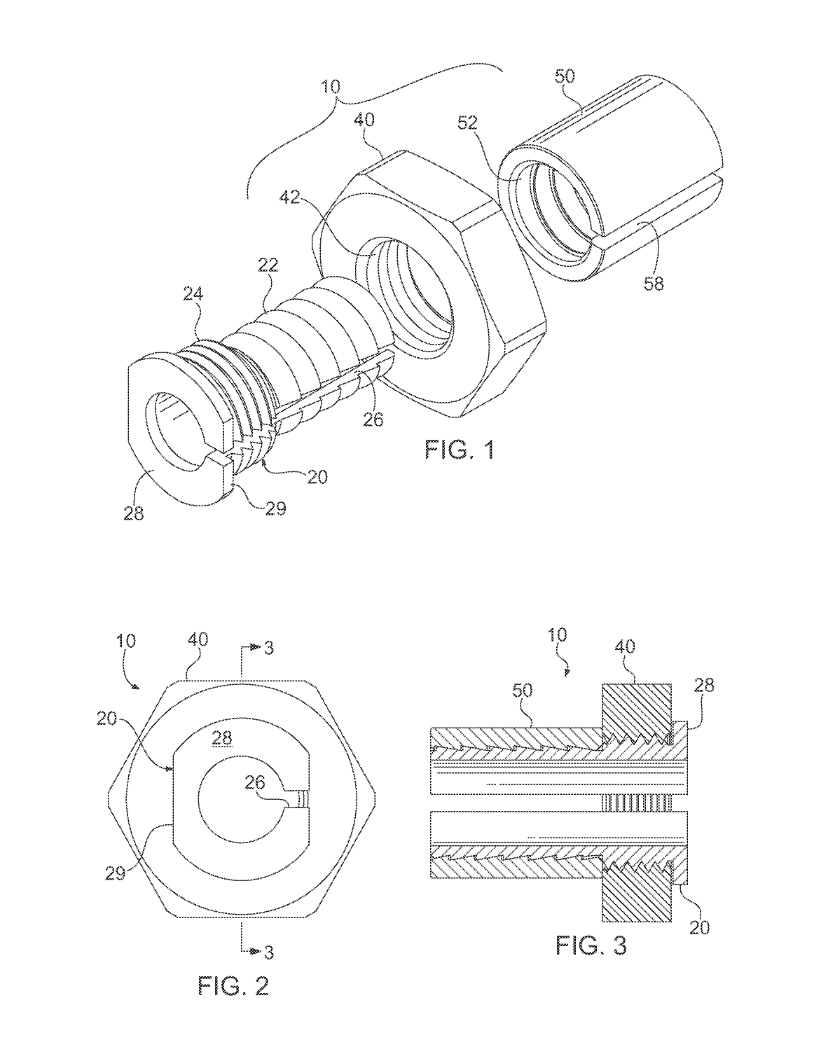

Referring now to the drawings in general and to FIGS. 1-5 specifically, a mounting device 10 designed to mount a machine element 5 onto a shaft 8 is illustrated. In the present instance, the shaft 8 is a cylindrical shaft and the machine element 5 has a smooth cylindrical bore 6 whose axis coincides with the axis of the cylindrical surface of the shaft 8. The mounting device is designed to be positioned between the bore 6 and the shaft 8 and securely anchor the machine element 5 on the shaft at any desired position axially along the shaft and any angular position around the shaft.

The mounting device 10 includes an inner sleeve 20, an outer sleeve 50, and a locking nut 40. The inner sleeve 20 is generally tubular, having an internal cylindrical bore with a diameter corresponding to the diameter of the shaft 8. Additionally, the diameter of the bore is sufficiently larger in diameter than the shaft 8 to allow the inner sleeve to slide on the shaft 8 axially and to rotate on the shaft to adjust the angular position of the device 10 relative to the shaft.

The outer sleeve 50 is a unitary sleeve having one or more axial slots 58 extending along the length of the outer sleeve. In the present instance, the outer sleeve has a single slot. The axial slot 58 permits radial deflection of the outer sleeve 50 as the mounting device 10 is tightened and loosened. The outer surface of the outer sleeve 50 is cylindrical having a diameter that corresponds to the bore 6 of the machine element. Additionally, the diameter of the outer sleeve is sufficiently smaller diameter than the bore to allow free sliding movement between the machine element and the outer sleeve when the mounting device is not tightened. Alternatively, although the device is illustrated as having a generally cylindrical outer surface, if the machine element has a tapered bore, the outer surface of the outer sleeve has a tapered frustoconical configuration having a taper that corresponds to the internal taper of the machine element bore. Similarly, the shaft may have an outer configuration other than cylindrical. In such an application, the inner bore of the inner sleeve is configured to mate with the non-cylindrical shaft surface.

The outer sleeve 50 is a single-piece hollow sleeve configured to receive the inner sleeve 20. Specifically, the inner surface of the outer sleeve 50 is configured to cooperate with the outer surface of the inner sleeve 20 to facilitate the selective radial expansion of the outer sleeve and radial contraction of the inner sleeve. In particular, the inner sleeve 20 and outer sleeve 50 have corresponding tapered surfaces that cooperate to expand the outer sleeve into engagement with the bore of the machine element 5 and to contract the inner sleeve into engagement with the shaft 8.

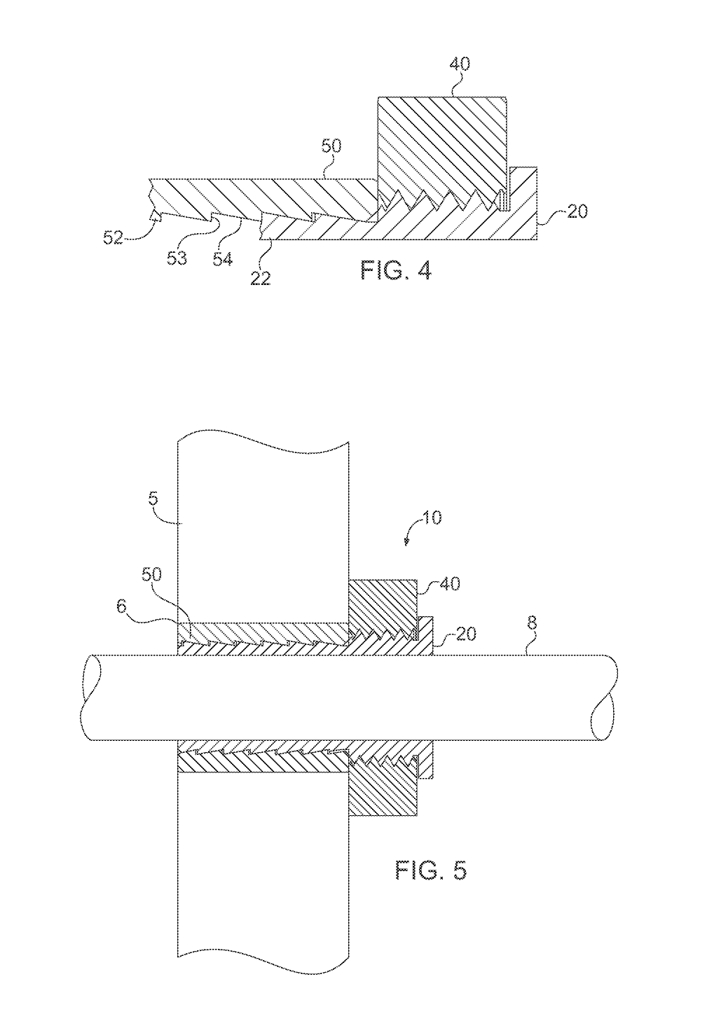

More specifically, the outer sleeve 50 comprises a plurality of tapered surfaces that angle outwardly from a minimum diameter to a maximum diameter. For instance, referring to FIGS. 3-4, the inner surface of the outer sleeve comprises a series of tapered surfaces, which in cross-section appear as a series of ramps. Although the tapered surfaces may be formed in any of a variety of configurations, in the present instance, the inner surface of the outer sleeve 50 comprises a buttress thread form. Referring to FIG. 4, in the present instance, the buttress thread form is a leadscrew thread having a load-bearing thread face 53 generally perpendicular to the central axis of the outer sleeve. The other thread surface 54 intersects the thread face at an angle. The angle may vary depending on the application, however, in the present instance the angle is between 45 and 88 degrees, and preferably is between 75 and 85 degrees. Additionally, the internal threaded section 52 of the outer sleeve 50 may be formed as a tapered thread, so that the thread diameter tapers along a line at an angle to the central axis of the outer sleeve; however, in the present instance, the threads are straight threads, so that the thread profile follows a line substantially parallel to the central axis of the outer sleeve.

In the above description, a buttress thread is described as a thread having a load-bearing thread-face 53 generally perpendicular to the central axis of the sleeve and a second thread surface intersecting the thread face at an angle. For the threaded surfaces of the device in general, and in particular with respect to the threaded portion of the outer sleeve, it should be understood that a flat or land may be formed at the thread apex (i.e. the intersection of the first and second thread faces, such as 53 and 54) and/or the thread valley (i.e. the area between threads). The size of the land may vary; it may be long relative to the thread base, such as in an acme thread, or the land may be shorter, such as in a V-thread.

The inner sleeve 20 is a generally cylindrical sleeve having an outer surface configured to cooperate with the inner surface of the outer sleeve. More specifically, the inner sleeve has an outer surface having a plurality of tapered surfaces configured to cooperate with the tapered surfaces formed on the interior surface of the outer sleeve. For example, in the present instance, the inner sleeve has a first threaded portion 22 formed to cooperate with the internal threads 52 of the outer sleeve 50. In the present instance, the external threads 22 on the inner sleeve comprise buttress threads that threadedly engage the internal buttress threads 52 of the outer sleeve 50. The externally threaded section 22 of the inner sleeve 50 may be formed as a tapered thread, so that the thread diameter tapers along a line at an angle to the central axis of the inner sleeve; however, in the present instance, the threads are straight threads, so that the thread profile follows a line substantially parallel to the central axis of the inner sleeve.

The inner sleeve 20 is configured to cooperate with a locking nut 40 operable to displace the inner sleeve axially relative to the outer sleeve. In the present instance, the first end of the inner sleeve comprises drive threads 24 that cooperate with the locking nut. The drive threads 24 may be any of a variety of thread profiles, however, in the present instance, the drive threads are V-threads having a root diameter that is larger than the internal diameter of the outer sleeve. In this way, the drive threads provide a stop, limiting the axial displacement of the inner sleeve relative to the outer sleeve. Specifically, in the present instance, the drive threads 24 impede displacement of the inner sleeve into the outer sleeve.

The outer sleeve 50 is displaced relative to the inner sleeve 20 by means of the nut 40. To this end, the nut 40 has internal threads 42 which threadedly engage the drive threads 24 of the inner sleeve 20. Specifically, in the present instance, the locking nut 40 comprises internal V-threads that cooperate with the drive threads at the end of the inner sleeve. Rotating the nut 40 displaces the inner sleeve axially relative to the outer sleeve.

Referring to FIG. 5, the nut has an internal bore that is larger than the diameter of the shaft 8. In addition, in the present instance, the outer diameter of the nut is larger than the outer diameter of the outer sleeve 50. In this way, when not tightened, the locking nut abuts the machine element being mounted on the shaft to position the element. Additionally, the inner sleeve 20 may include a circumferential flange extending radially outwardly from the end of the inner sleeve. Referring to FIGS. 1-3, In the present instance, the flange 28 is located at the end of the inner sleeve, adjacent the drive threads 24. The inner sleeve 20 further comprises one or more axial slots extending along the length of the sleeve. In the present instance, a single slot is utilized. The slot may be a terminated slot, however, in the present instance the slot 26 extends along the entire length of the inner sleeve. The slot 26 allows the inner sleeve to contract or expand in diameter in response to the interaction of the cooperating tapered surfaces of the inner and outer sleeve 20, 50.

The locking nut 40 is removably connectable with the inner sleeve 20. Specifically, the locking nut connects with the inner sleeve via the cooperating inner threads 42 of the locking nut and the drive threads 24 of the inner sleeve. Additionally, in the present instance, the locking nut has a larger internal diameter than the major diameter of the buttress threads formed in the inner sleeve 50. In this way, the nut 40 is configured to pass over the buttress threads of the inner sleeve without engaging the buttress threads.

The device 10 is assembled as follows. The inner sleeve 20 is inserted through the locking nut until the drive threads 24 on the inner sleeve engage the internal threads of the locking nut 50. The locking nut 40 is then threaded onto the drive threads 24 of the inner sleeve 20. The inner sleeve 20 is then threaded into the outer sleeve 50 by threading the buttress threads 22 of the inner sleeve into buttress threads 52 of the outer sleeve.

The device 10 is operated as follows. After being assembled as described above, the device 10 inserted onto a shaft 8 so that the shaft extends through the inner bore of the inner sleeve 20. The device 10 is then inserted into the bore 6 of a machine element 5. Alternatively, the device may be inserted into the machine element before being mounted onto the shaft.

Before tightening, the inner bore of the inner sleeve is larger than the diameter of the shaft 8, so that the device 10 can slide along the length of the shaft to position the device at a desired axial position. Similarly, prior to being tightened, the outer diameter of the outer sleeve 50 is smaller than the bore 6 of the machine element 5, so that the machine element can slide angularly relative to the device and the shaft to angularly position the machine element. In this way, the angular and axial position of the machine element relative to the shaft can be readily adjusted prior to tightening the device.

After the machine element 5 is positioned on the device 10 and along the shaft, the device is tightened by rotating the locking nut 40 in a first direction. However, prior to operating the locking nut, it may be desirable to snug up the assembly by rotating the inner sleeve relative to the outer sleeve. The inner sleeve 20 may include a surface cooperable with a tightening tool to facilitate rotating the inner sleeve relative to the outer sleeve so that the inner sleeve is threaded along the inner threads 52 of the outer sleeve. For instance, in the present instance, the flange 28 includes flat surfaces 29 configured to cooperate with a wrench to rotate the inner sleeve, thereby threading the inner sleeve into or out of the outer sleeve, depending on the configuration of the threaded portions 22, 52. In the present instance, the flats 29 comprise a pair of substantially parallel surfaces for rotating the inner sleeve 20.

As mentioned above, the device 10 locks onto the shaft 8 and the machine element 5 by rotating the locking nut 40. Specifically, when the locking nut 40 abuts the outer sleeve 50, rotating the locking nut relative to the inner sleeve in a first direction drives the locking nut against the outer sleeve to drive the outer sleeve forwardly relative to the inner sleeve 20. To rotate the locking nut 40 relative to the inner sleeve, a torque is applied to the locking nut 40 while a counter-torque is applied to the inner sleeve 20. For instance, a wrench may engage the nut to apply a torque to the locking nut, while a second wrench may engage the flats 29 on the flange to apply a torque opposite the direction of the torque applied to the locking nut. Once the outer sleeve engages the machine element the resulting radial forces substantially impede rotation of the outer sleeve relative to the machine element and/or the inner sleeve. Therefore, the counter-torque can be applied by anchoring the machine element while the locking nut is rotated to tighten the device. Either way, applying a torque to the locking nut in a first direction and a counter-torque to the inner sleeve operates to drive the inner sleeve axially forwardly relative to the outer sleeve. Driving the outer sleeve forwardly drives the outer sleeve to the left from the perspective of FIG. 3.

The relative axial displacement of the inner and outer sleeves drives the tapered surfaces of the internal buttress threads 52 on the outer sleeve up the tapered surfaces of the outer buttress threads 22 of the inner sleeve, creating a clamping force directed radially outwardly on the machine element 5 and radially inwardly on the shaft 8. In other words, the corresponding tapered surfaces of the threads provide a wedging force so that diameter of the outer sleeve expands into the bore of the machine element to lock into the machine element and the bore of the inner sleeve contracts onto the shaft to lock the device onto the shaft.

As the locking nut 40 is rotated in the first direction to tighten the device 10, the inner sleeve may rotate relative to the outer sleeve. However, once the outer sleeve engages the bore of the machine element and the inner sleeve engages the shaft, the torque rotating the locking nut 40 operates to drive the outer sleeve 50 forwardly relative to the inner sleeve without significant rotation of the inner sleeve relative to the outer sleeve. Accordingly, rotating the nut tightens the device by driving the inner sleeve axially relative to the outer sleeve without substantially displacing the inner sleeve angularly relative to the outer sleeve. More specifically, rotating the nut tightens the device by driving the inner sleeve axially relative to the outer sleeve further than the inner sleeve is driven angularly relative to the outer sleeve. The frictional force resisting rotation between the engaging threads of the inner and outer sleeves is much higher than the frictional force between the nut and the inner sleeve or the face of the nut and the outer sleeve that would cause rotation of the inner or outer sleeve. Specifically, the wedge effect of the tapered thread causes a higher radial force for a given axial force. Therefore, the resulting forces will tend to impede rotation of the inner sleeve relative to the outer sleeve as the nut is rotated to tighten the unit.

Once locked onto the shaft 8 and the machine element 5, the device can be loosened to reposition the machine element by rotating the locking nut 40 in a second direction, opposite the first direction. Specifically, driving the locking nut 40 in the second direction drives the locking nut away from the outer sleeve and rearwardly on the inner sleeve 20, toward the flange 28. Rotating the locking nut in the reverse direction reduces or removes the axial force wedging the tapered surfaces of the mating threads together. Depending on the configuration of the mating threads 22, 52, the inner sleeve may tend to automatically release from the outer sleeve when the locking nut is loosened. However, in certain configurations the tapered surfaces of the mating threads may be at least moderately self-locking, so that the inner and outer sleeves remain locked together after the locking nut is loosened. Accordingly, after the locking nut is loosened, the inner sleeve may be loosened from the outer sleeve by applying a torque to rotate the inner sleeve relative to the outer sleeve.

For instance, in the present instance, loosening the locking nut displaces the locking nut toward the flange 28 on the inner sleeve 20. Once the locking nut abuts the flange 28, the flange operates as a stop impeding rotational displacement of the locking nut relative to the inner sleeve in the reverse direction. Accordingly, continued displacement of the locking nut in the reverse direction applies a torque to the inner sleeve tending to rotate the inner sleeve. Since the outer sleeve 50 remains engaged with the machine element 5, the machine element 5 may be anchored by hand or otherwise to impede rotation of the outer sleeve, so that rotating the inner sleeve tends to rotate the inner sleeve relative to the outer sleeve. In other applications the device may be loosened by applying the loosening torque to the inner sleeve without the need to separately anchor the outer sleeve. In this way, rotating the locking nut 40 in the second direction drives the tapered surfaces of the threads in the outer sleeve down the tapered surfaces of the threads on the inner sleeve thereby allowing the outer sleeve to resiliently contract inwardly loosening the outer sleeve from the bore of the machine element and allowing the inner sleeve to resiliently expand outwardly loosening the inner sleeve from the shaft. Accordingly, driving the locking nut in the first direction forcefully tightens the device onto the machine element and the shaft by driving the inner sleeve axially relative to the outer sleeve and driving the locking nut in the second direction forcefully loosens the device from the machine element and the shaft by rotating the inner sleeve relative to the outer sleeve.

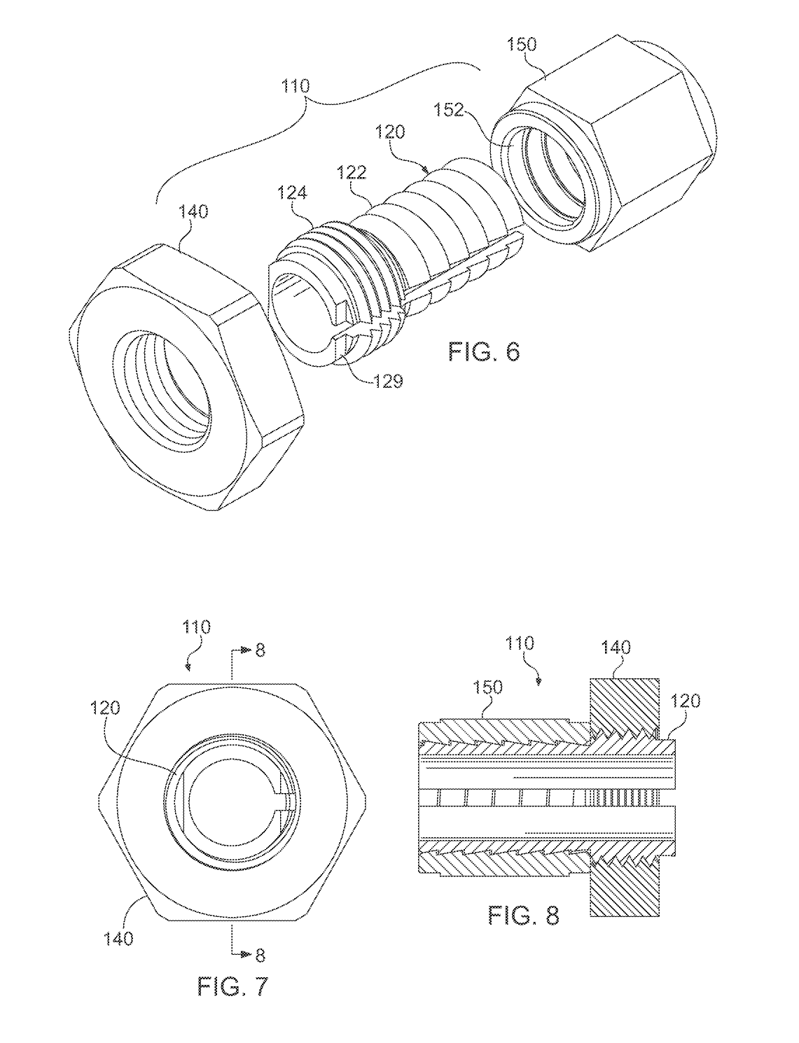

An alternative embodiment for a mounting device 110 is illustrated in FIGS. 6-8. In this first alternative embodiment, the outer sleeve is configured to be fixedly connected with the machine element. Referring to FIG. 6, the device comprises an outer sleeve 150, an inner sleeve 120 and a locking nut 140. The locking nut 140 is configured substantially similarly to the locking nut 40 described above in the first embodiment.

The outer sleeve 150 comprises a hollow sleeve having an internally threaded section 152. The threaded section 152 may have any of a variety of thread profiles. However, in the present instance, the internal threaded section 152 is configured substantially similarly to the threaded section 52 discussed above in the first embodiment.

The outer sleeve 150 comprises an outer surface configured to fixedly connect the outer sleeve with the bore of the machine element 108. In the present instance, the outer surface is formed with a plurality of planar surfaces. Specifically, the outer surface comprises a hexagonal configuration. The bore of the machine element may comprise a corresponding configuration. For instance, the bore may have a hexagonal configuration to cooperate with the external surface of the outer sleeve 150. In this way, the mating surfaces impede rotation of the outer sleeve relative to the machine element. Additionally, the outer sleeve may be formed so that the outer surface 151 forms an interference fit with the bore of the machine element so that the outer sleeve is rigidly connected with the machine element. However, in the present instance, the outer sleeve 150 is formed as an insert to be molded into a rotatable element (i.e. a machine element). For instance, the outer sleeve 150 may be inserted into a mold, such as a mold for forming a plastic component. Specifically, the outer sleeve 150 may be positioned in a mold at a location corresponding to the hub of the element to be formed. After the outer sleeve is positioned in the mold, molten material is injected into the mold. The molten material may be any of a variety of plastic or metal materials. For instance, the molten material may be a thermoplastic material. The material is then cooled or cured. In this way, the component is fixedly formed into the hub of the machine element, so that the outer sleeve will not rotate relative to the machine element. Additionally, in contrast to the first embodiment, the outer sleeve 150 is formed without an axial slot, so that the outer sleeve is a continuous sleeve that substantially resists radial deformation. In this way, the outer sleeve substantially resists outward radial deformation, thereby limiting or preventing radial forces being transmitted to the hub of the machine element in response to the device being tightened.

The inner sleeve 120 is configured similarly to the inner sleeve 20 described above in connection with the first embodiment 10. Specifically, the inner sleeve comprises a first threaded portion 122 cooperable with the internal threads 152 of the outer sleeve 150. The inner sleeve 120 further comprises a second threaded portion 124. As with the previously described embodiment, the second threaded portion 124 may be a continuation of the first threaded portion 122. However, in the present instance, the second threaded portion has a different thread profile than the first threaded portion, similar to the embodiment described above. Although the threaded sections may have any of a variety of profiles, in the present instance, the first threaded section 122 is a buttress thread profile, similar to the buttress threaded portion 22 described above in connection with the first embodiment and the second threaded portion 124 is a v-thread configured to mate with the threads in the locking nut 140. Although the inner sleeve 120 may include a flange as described above in connection with the first embodiment, in the present embodiment 110, the inner sleeve 120 does not include a circumferential flange. However, at the end of the inner sleeve, adjacent the second threaded portion 124, a pair of engagement surfaces 129 for engaging a tightening tool. For example, in the present instance, the inner sleeve comprises a pair of opposing flat surface for engaging a wrench or similar tightening device.

In operation, the device 110 is used by mounting the outer sleeve 150 in the bore of the machine element. The outer sleeve may be releasably connected with the machine element, however, in the present instance, the outer sleeve is fixedly connected with the machine element to substantially permanently connect the outer sleeve with the machine element. For example, the outer sleeve 150 may be molded into the machine element to connect the machine element and the outer sleeve.

Once the outer sleeve is connected with the machine element, the inner sleeve is threaded into the outer sleeve 150 by driving the first threads 122 of the inner sleeve through the internal threads 152 of the outer sleeve. Since the outer sleeve is already rigidly connected with the machine element, tightening and loosening the device simply tightens and loosens the inner sleeve to the outer sleeve and the shaft. Specifically, rotating the locking nut 140 on the second threads 124 in a first direction displaces the inner sleeve axially relative to the outer sleeve without substantially displacing the inner sleeve angularly Displacing the inner sleeve 120 in the first direction axially relative to the outer sleeve drives the tapered surfaces of the threads of the outer sleeve up the tapered surfaces of the first threads 122 of the inner sleeve, thereby locking the inner sleeve to the outer sleeve and deflecting the inner sleeve radially inwardly to clamp the inner sleeve onto the shaft 105.

Once the device 110 is tightened, it can be loosened by rotating the locking nut 140 in a second direction, opposite the first direction. After the locking nut is loosened, the inner sleeve may stay locked with the outer sleeve depending on the geometry and materials used to form the sleeves. If the sleeves remain locked, rotating the inner sleeve in the second direction drives the inner sleeve 120 angularly relative to the outer sleeve. For instance, the inner sleeve may be rotated by engaging the flats 129 with a wrench. Rotating the inner sleeve drives the tapered surfaces of the inner threads of the outer sleeve down the tapered surfaces of the outer threads of the inner sleeve, thereby loosening the device to reduce the clamping force between the inner sleeve and the shaft and between the inner sleeve and the outer sleeve. However, rotating the locking nut and/or the inner sleeve in the reverse direction does not loosen the outer sleeve from engagement with the machine element.

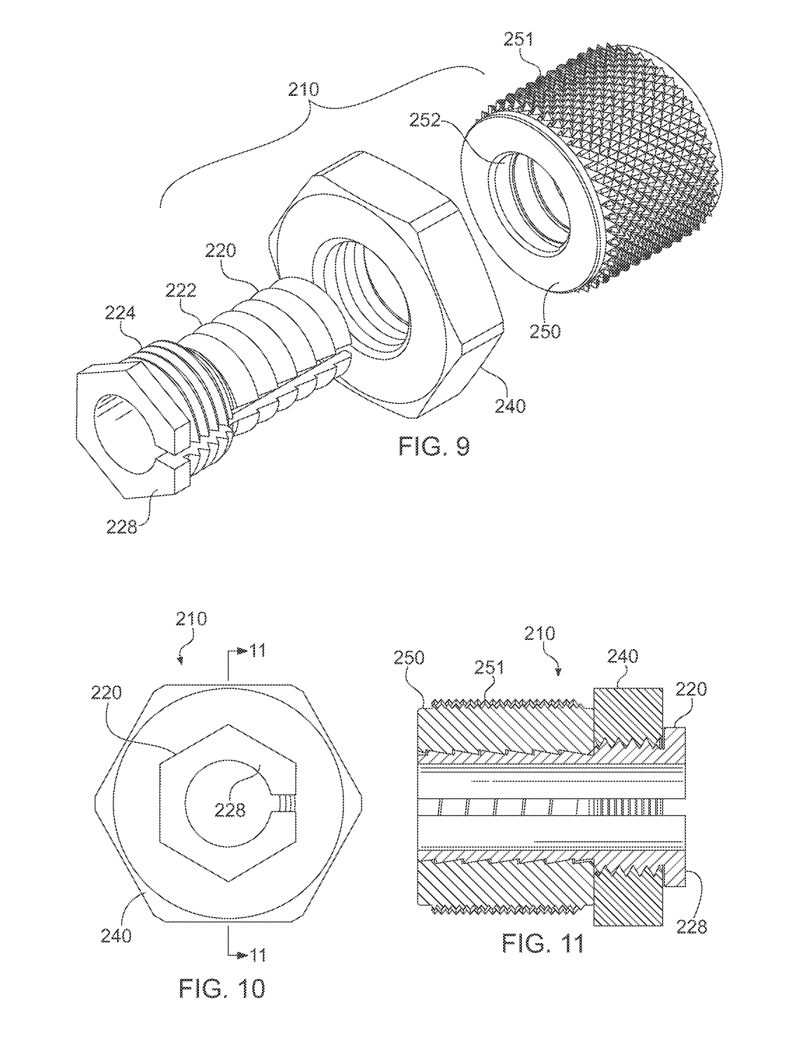

Referring now to FIGS. 9-11 an alternative mounting device 250 is illustrated. Like the mounting device 110 described above, the mounting device 210 has an outer sleeve 250 configured to be fixedly connect with the machine element. Specifically, the outer sleeve 250 is a hollow sleeve having internal threads and is without an axial slot, similar to the outer sleeve 150 described above.

In the present instance, the outer sleeve 250 comprises an outer surface 251 configured to fixedly connect the outer sleeve with a machine element. Specifically, the outer surface 251 comprises a knurled surface to facilitate an interference fit with the machine element. Specifically, the machine element has a bore sized to cooperate with the outer surface of the outer sleeve. For instance, the bore may be slightly smaller than the outer diameter of the knurled surface of the outer sleeve. In this way, the outer sleeve may be press fit into the bore so that the outer sleeve 250 is substantially permanently fixed to the machine element. Alternatively, the outer sleeve 250 may be injection molded into the hub of a machine element as described above in connection with mounting device 110. The knurled surface 251 will impede rotation of the outer sleeve relative to the machine element when a torque is applied to either the outer sleeve or the machine element.

The inner sleeve 220 is configured substantially similarly to the inner sleeve 20 described above in connection with the first embodiment. Specifically, the inner sleeve 220 has a first threaded portion 222 and a second threaded portion 224. The two threaded portions may have any of a variety of threaded profiles and may have the same profile. However, in the present instance, the first threaded portion has a buttress thread profile to cooperate with the internal threaded portion 252 on the outer sleeve and the second threaded portion 224 has a v-thread profile to cooperate with internal threads of the locking nut 240, which is substantially similar or identical to the locking nut 40 described above.

The inner sleeve 220 further comprises a flange 228 adjacent the second threaded section 224, wherein the flange projects radially outwardly. In this way, the locking nut abuts the mounting nut to displace the sleeve axially relative to the inner sleeve when the nut is rotated in a first direction to drive the inner sleeve axially relative to the outer sleeve, similar to the operation of the device 10 discussed above. In this way, the device is tightened and loosened similar to the device 10 discussed above, except that rotating the nut in a first direction does not expand the outer sleeve into locking engagement with the machine element and loosening the device does not contract the outer sleeve out of engagement with the machine element. Instead, once the outer sleeve is fixed to the machine element, rotating the nut in a first direction tightens the device by driving the inner sleeve axially rearwardly relative to the outer sleeve without substantially displacing the inner sleeve angularly relative to the outer sleeve. Similarly, rotating the locking nut in a second direction loosens the nut, and then applying a torque to the inner sleeve in a second direction (such as by a wrench engaging the flats 228) rotates the inner sleeve relative to the outer sleeve to loosen the inner sleeve from the shaft.

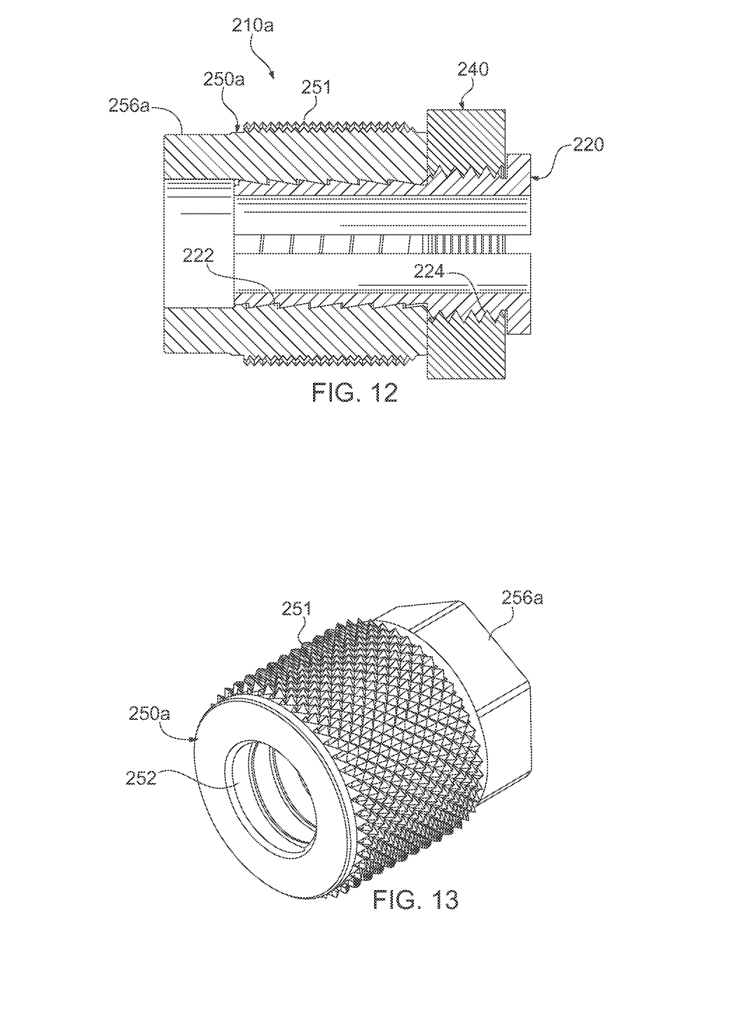

Referring to FIGS. 12-13 a variation of the device illustrated in FIGS. 9-11 is designated 210a. The mounting device 210a includes an inner sleeve 220 and locking nut 240 that are the same as described above in connection with the embodiment illustrated in FIG. 9-11. The outer sleeve 250a is also similar to the outer sleeve 250 described above. Elements of outer sleeve 250a that are the same as corresponding elements in the outer sleeve 250 described above are labeled with the same number used above; elements that are different are identified with a reference number that includes the letter “a”.

The outer sleeve 250a comprises a single-piece generally cylindrical hollow sleeve having internal threads 252, and in the present instance, the outer sleeve 250a is a solid sleeve having an external configuration 251 configured to impede rotation of the outer sleeve relative to a machine element. For instance, the sleeve 250a comprises knurled outer surface 251.

Outer sleeve 250a further comprises an external surface 256a configured to engage a tightening tool, such as a wrench. For instance, the outer sleeve may comprise a flange or shoulder for engaging a tool to provide torque to the outer sleeve. Referring to FIG. 13, in the present instance, the outer sleeve 250a comprises a plurality of parallel wrench flats, such as a hex configuration, for engaging a wrench or socket.

Referring to FIG. 12, the device 210a is assembled by threading the locking nut onto the second threaded portion 224 of the inner sleeve 220. The first threaded portion 222 of the inner sleeve is then threaded into the outer sleeve 250a. In the present instance, the inner sleeve 220 is threaded into the outer sleeve 250 through the end opposite the hex head 256a. In this way, the hex head 256a of the outer sleeve is spaced apart from the locking nut 240 when the device is assembled. Additionally, similar to sleeve 250, the portion of the outer sleeve having a knurled surface 251 has a length that is approximately the thickness of the machine element to be connected with the device. Therefore, when the mounting device 210a is connected with the machine element as described above, the machine element overlies the knurled surface and the hex head 256a protrudes from the side of the machine element opposite from the side that the mounting nut 240 and inner sleeve 220 protrude.

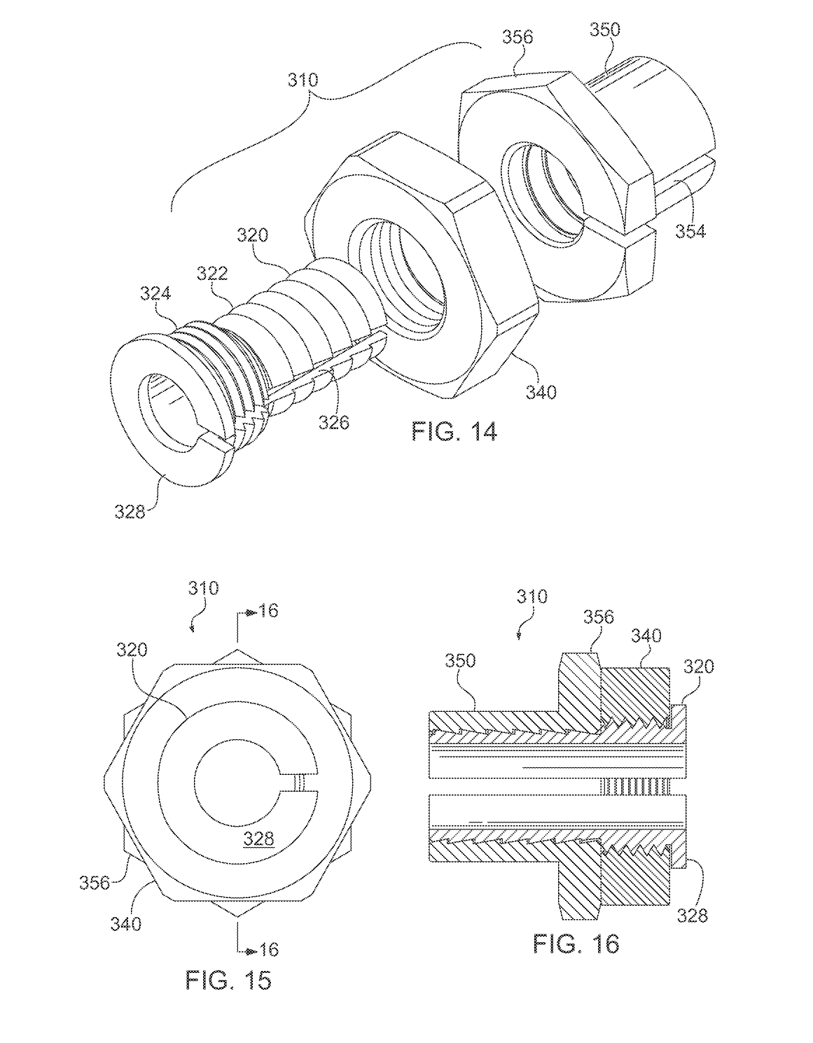

Referring now to FIGS. 14-16 an alternate mounting device 310 is illustrated. The mounting device 310 is configured similarly to the mounting device 10 described above. Specifically, the device 310 includes a hollow outer sleeve 350 having internal threads that cooperate with external threads on a hollow inner sleeve 320. The external surface of the outer sleeve 350 is configured to releasably connect with the bore of a machine element and the inner bore of the inner sleeve 320 is configured to receive a shaft so that the inner sleeve can be releasably connected with the shaft.

The outer sleeve 350 comprises one or more longitudinal slots 354 to allow the outer sleeve to radially expand into engagement with the bore of the machine element when the device is tightened. Similarly, the inner sleeve 320 comprises one or more longitudinal slots 326 to allow the inner sleeve to contract radially inwardly to lock onto the shaft when the device is tightened. Additionally, both the inner sleeve 320 and the outer sleeve 350 are formed of a resiliently deformable material, such as steel, so that upon loosening, the outer sleeve resiliently contracts and the inner sleeve resiliently expands to loosen from the machine element and the shaft as described above in connection with the first embodiment 10.

The outer sleeve 350 further comprises a surface cooperable with a tightening tool. For instance, in the present instance, the outer sleeve comprises a flange extending radially outwardly and having a plurality of flat surfaces adapted to cooperate with a wrench or other tool for tightening or loosening the device 310. Specifically, in the present instance, the flange 356 is hexagonally shaped having opposing parallel surface cooperable with a socket wrench, box wrench or the like. In this way, the flange 356 provides a surface for restraining the outer sleeve to provide a counter-torque to rotate the nut relative to the inner sleeve as discussed above in connection with the first embodiment 10.

The inner sleeve 320 is configured substantially similarly to the inner sleeve 20 described previously in connection with the first mounting device 10 described above. However, in the present instance, the flange 328 of the inner sleeve does not have flat surfaces for engaging a tightening tool. Instead, the flange 356 on the outer sleeve is used.

Configured in this way, the mounting device 310 operates substantially similarly to the mounting device 10 described above except that the counter-torque is applied directly to the outer sleeve 350 instead of directly to the inner sleeve during the tightening process.

Referring now to FIGS. 15-17, yet another embodiment of a mounting device 410 is illustrated. The mounting device 410 comprises an inner sleeve 420 and an outer sleeve 450 and a locking nut 440 for releasably locking the device to a shaft.

In the present instance, the inner sleeve 420 comprises a hollow generally cylindrical split sleeve having an internal bore configured to mate with a cylindrical shaft. As in the embodiments described above, the inner sleeve 420 comprises a first threaded section 422 cooperable with internal threads 452 in the outer sleeve 450 and a second threaded section 424 cooperable with internal threads in the locking nut 440. The threaded portions may be configured in a variety of profiles, however, in the present instance, the externally threaded portions 422, 424 of the inner sleeve and the internally threaded portions of the outer sleeve 450 and the locking nut 440 are configured substantially similarly to the threaded portions 22, 24 42, 52 of the mounting device 10 described above. Additionally, in the present embodiment, the inner sleeve 420 does not include a flange extending radially outwardly as described above in connection with the inner sleeve 20 of the mounting device 10 described above.

The outer sleeve may be a split sleeve that is radially resiliently deformable to releasably lock the outer sleeve to the bore of a machine element as discussed above in connection with the mounting device 10. However, in the present embodiment, the outer sleeve is a solid sleeve configured to be substantially permanently fixed to the bore of the machine element as described above in connection with the mounting device 110 described above.

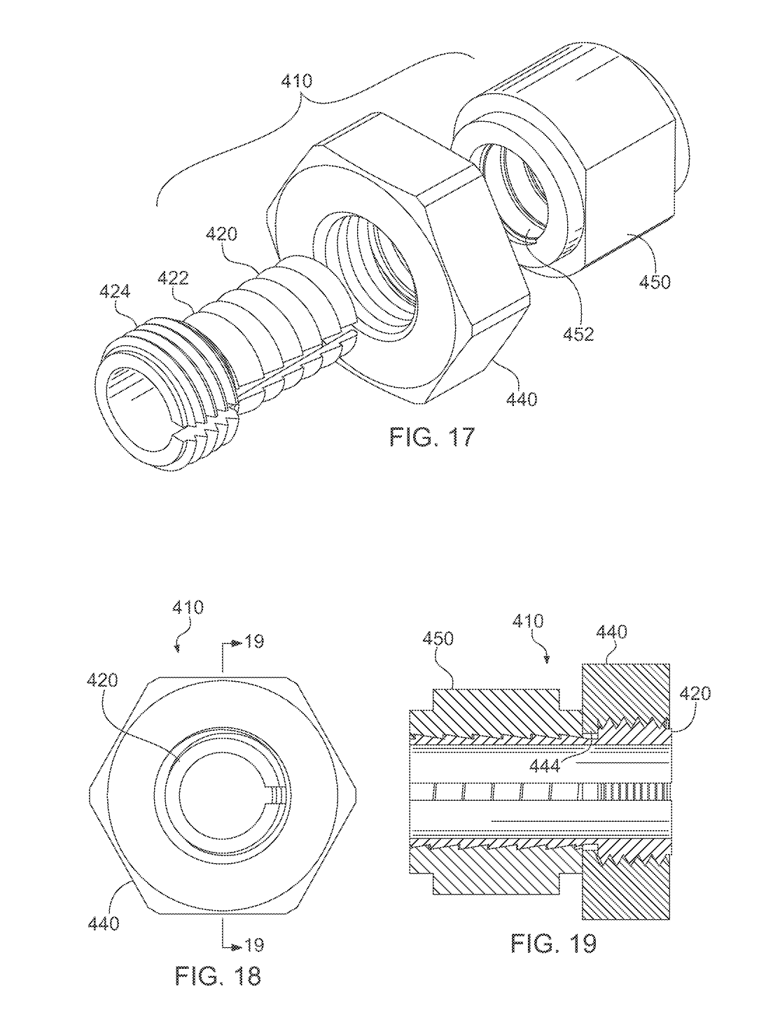

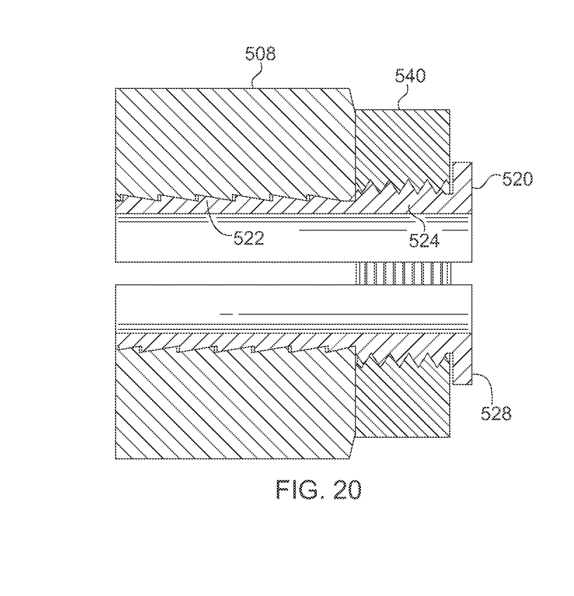

Referring to FIG. 17, the locking nut 440 comprises an internal flange 444 configured to abut a shoulder on the inner sleeve 420 to displace the inner sleeve relative to the outer sleeve 450. Specifically, the flange 444 extends radially inwardly, and in the present instance, the flange is an annular flange extending around the bore of the locking nut. In the present instance, the second threaded section 424 of the inner sleeve has a larger diameter than the first threaded portion 422, so that a shoulder is formed at an end of the second threaded section. In this way, rotating the locking nut in a first direction relative to the inner sleeve 420 drives the locking nut against the outer sleeve, which displaces the outer sleeve axially relative to the inner sleeve to tighten the device as described above. To loosen the device 410, the locking nut is rotated in the second direction relative to the inner sleeve until the flange 444 engages the shoulder on the inner sleeve. At this point, the locking nut will not continue to rotate relative to the inner sleeve, so that continued rotation of the locking nut rotates the inner sleeve as well. In this way, rotating the locking nut 440 rotates the inner sleeve relative to the outer sleeve to loosen the device similar to how the first embodiment described above is loosened.

The construction also enables the units to be fabricated from materials other than metal where the operating conditions are such as to limit the selection of the material used in fabricating the parts.

In the foregoing description, the term machine element has been described as including elements such as a pulley or gear. However, it should be understand that the term machine element is not intended to be limited to pulleys and gears. Instead, the term machine element refers to any element to be mounted onto a rotatable element, such as a shaft to rotate with the rotatable element.

It will be recognized by those skilled in the art that changes or modifications can be made to the above-described embodiments without department from the broad inventive concept of the invention. For instance, in the foregoing description, the mounting device is described as having an outer sleeve and an inner sleeve. In several embodiments, the outer sleeve is configured to be substantially permanently attached to the machine element. Additionally, rather that utilizing a separate outer sleeve, the machine element may be modified to directly engage the inner sleeve. For instance, Referring to FIG. 18, the machine element 508 may be modified to have internal threads that mate with the first portion 522 of the external threads of the inner sleeve 520. Specifically, the machine element may comprise an internally threaded bore having a buttress thread profile cooperable with the external buttress threads of the inner sleeve. In this way, rotating the locking nut 540 drives internal threads of the locking nut on the second threaded portion 524 of the inner sleeve. The inner sleeve 520 and the locking nut 540 are configured substantially similarly to the inner sleeve 20 and locking nut 40 described above in connection with the first mounting device 10. Accordingly, rotating the locking nut in a first direction drives the inner sleeve axially relative to the machine element 508 without substantially driving the inner sleeve angularly relative to the machine element. In this way, the threads of the inner sleeve are driven axially up the threads of the machine element so that the inner sleeve contracts radially onto the shaft, thereby locking the inner sleeve onto the shaft. At the same time, driving the threaded surfaces of the inner sleeve axially relative to the threaded surfaces of the machine element without rotating the inner sleeve relative to the machine element cooperates to lock or fix the inner sleeve relative to the machine element. Additionally, the inner sleeve can be released from the machine element and the shaft by rotating the locking nut 540 in a second direction reverse the first direction.

Further still, as described above, various features from each of the embodiments can be incorporated into other embodiments. For instance, in the embodiment disclosed in FIG. 15, the locking nut 440 incorporates a flange for engaging the inner sleeve to loosen the device whereas in the first embodiment the flange is positioned on the inner sleeve. It should be understood that these and other features can be interchanged among the various embodiments.

It should therefore be understood that this invention is not limited to the particular embodiments described herein but is intended to include all changes and modifications that are within the scope and spirit of the invention as set forth in the following claims.

1. A mounting device for mounting a machine element having a bore onto a shaft, comprising:
a hollow outer sleeve having an outer diameter similar to the bore of the machine element, wherein the outer sleeve comprises internal threads;
a hollow inner sleeve having an internal diameter similar to a diameter of the shaft, wherein the inner sleeve comprises:
a first threaded portion cooperable with the internal threads of the outer sleeve, wherein the first threaded portion comprises a buttress thread profile; and
a second threaded portion; and
a locking nut comprising internal threads cooperable with the second threaded portion of the inner sleeve;
wherein the device is tightened by rotating the locking nut in a first direction to drive the inner sleeve axially relative to the outer sleeve without substantially driving the inner sleeve angularly relative to the outer sleeve, wherein driving the inner sleeve axially relative to the outer sleeve drives the internal threads of the outer sleeve up the first threaded portion of the inner sleeve thereby expanding the outer sleeve into locking engagement with the machine element and contracting the inner sleeve inwardly into locking engagement with the shaft.

2. The mounting device of claim 1 wherein the thread profile of first threaded portion is different from the thread profile of the second threaded portion.

3. The mounting device of claim 1 wherein the device is loosened by rotating the locking nut in a second direction and driving the inner sleeve rotationally relative to the outer sleeve so that the internal threads of the outer sleeve are driven down the first threaded portion of the inner sleeve and the outer sleeve resiliently contracts inwardly away from the bore and the inner sleeve resiliently expands outwardly away from the shaft.

4. The mounting device of claim 1 wherein the inner sleeve comprises a flange extending radially outwardly adjacent the second threaded portion.

5. The mounting device of claim 4 wherein the locking nut engages the flange to drive the inner sleeve relative to the outer sleeve.

6. The mounting device of claim 1 wherein the inner sleeve comprises a surface configured to mate with a tightening tool.

7. The mounting device of claim 1 wherein the inner sleeve comprises a longitudinal slot to allow the inner sleeve to readily deflect radially in response to axial displacement of the inner sleeve relative to the outer sleeve.

8. The mounting device of claim 1 wherein the locking nut has a bore larger than a major diameter of the first threaded portion of the inner sleeve.

9. The mounting device of claim 1 wherein the first and second threaded portions are external threads.

10. A mounting device for mounting a machine element onto a shaft, comprising:
a hollow outer sleeve comprising internal threads;
a hollow inner sleeve having a bore configured to mate with the shaft, wherein the inner sleeve comprises:
a first threaded portion cooperable with the internal threads of the outer sleeve; and
a second threaded portion; and
a locking nut comprising internal threads cooperable with the second threaded portion of the inner sleeve;
wherein the device is tightened by rotating the locking nut in a first direction to drive the inner sleeve axially relative to the outer sleeve without substantially driving the inner sleeve angularly relative to the outer sleeve, wherein driving the inner sleeve axially relative to the outer sleeve drives the internal threads of the outer sleeve up the first threaded portion of the inner sleeve thereby contracting the inner sleeve inwardly into locking engagement with the shaft.

11. The mounting device of claim 10 wherein the thread profile of the first threaded portion of the inner sleeve is different from the thread profile of the second threaded portion.

12. The mounting device of claim 10 wherein the thread profile of the first threaded portion of the inner sleeve is a buttress thread.

13. The mounting device of claim 10 wherein the outer sleeve is molded into the machine element.

14. The mounting device of claim 10 wherein the inner sleeve comprises a flange extending radially outwardly adjacent the second threaded portion.

15. The mounting device of claim 14 wherein the locking nut engages the flange to drive the inner sleeve relative to the outer sleeve.

16. The mounting device of claim 10 wherein the inner sleeve comprises a longitudinal slot to allow the inner sleeve to readily deflect radially in response to axial displacement of the inner sleeve relative to the outer sleeve.

17. The mounting device of claim 10 wherein the locking nut has a bore larger than a major diameter of the first threaded portion of the inner sleeve.

18. The mounting device of claim 10 wherein the outer surface of the outer sleeve comprises a feature configured to impede rotation of the outer sleeve relative to the machine element.

19. The mounting device of claim 10 wherein the outer sleeve comprises a surface configured to rigidly connect the outer sleeve with the machine element when the mounting device is loosened.

20. The mounting device of claim 10 wherein the outer sleeve is substantially inflexible radially to impede radial expansion or contraction of the outer sleeve when the locking nut is rotated in the first direction to tighten the device.

21. The mounting device of claim 10 wherein the outer sleeve is press fit into the bore of the machine element so that the outer sleeve forms an interference fit with the machine element.

22-37. (canceled)

38. A device for mounting a machine element on a shaft, comprising:
a hollow outer sleeve forming a continuous band to resist radial expansion when the device is tightened, wherein the outer sleeve has internal threads having a buttress profile, wherein the outer sleeve comprises a surface configured to impede rotation of the outer sleeve relative to the machine element when the outer sleeve is molded into the machine element;
an inner sleeve connected to the outer sleeve in the machine element, wherein the inner sleeve has external threads cooperable with the internal threads in the outer sleeve, wherein the external threads of the inner sleeve threadedly engage the internal threads of the outer sleeve, wherein the inner sleeve is generally hollow having a bore for receiving a shaft;
wherein rotating the inner sleeve in a first direction drives tapered surfaces of the external threads up tapered surfaces of the internal threads to lock the inner sleeve to the outer sleeve and the inner sleeve to the shaft.

39. The mounting device of claim 38 wherein the external threads of the inner sleeve comprises a first threaded portion and a second threaded portion, and wherein the thread profile of the first threaded portion is different from the thread profile of the second threaded portion.

40. The mounting device of claim 39 wherein the thread profile of the first threaded portion of the inner sleeve is a buttress thread.

41. The mounting device of claim 38 wherein the outer sleeve is molded into the machine element.

42. The mounting device of claim 38 wherein the inner sleeve comprises a flange extending radially outwardly.

43. The mounting device of claim 42 wherein the locking nut engages the flange to drive the inner sleeve relative to the outer sleeve.

44. The mounting device of claim 38 wherein the inner sleeve comprises a longitudinal slot to allow the inner sleeve to readily deflect radially in response to axial displacement of the inner sleeve relative to the outer sleeve.

45. The mounting device of claim 39 wherein the locking nut has a bore larger than a major diameter of the first threaded portion of the inner sleeve.

46. The mounting device of claim 38 wherein the outer surface of the outer sleeve comprises a feature configured to impede rotation of the outer sleeve relative to the machine element.

47. The mounting device of claim 38 wherein the outer sleeve comprises a surface configured to rigidly connect the outer sleeve with the machine element when the mounting device is loosened.

48. The mounting device of claim 38 wherein the outer sleeve is substantially inflexible radially to impede radial expansion or contraction of the outer sleeve when the locking nut is rotated in the first direction to tighten the device.

49. The mounting device of claim 38 wherein the outer sleeve is press fit into the bore of the machine element so that the outer sleeve forms an interference fit with the machine element.

50-56. (canceled)
